(19) United States
(12) Patent Application Publication
(10) Pub. No.: US 2026/0172811 A1
(43) Pub. Date: Jun. 18, 2026

(54) SYSTEMS AND METHODS FOR INTELLIGENT MOBILE DEVICE ESIM SKU MAPPING

(71) Applicant: VERIZON PATENT AND LICENSING INC., Basking Ridge, NJ (US)

(72) Inventors: Zhengfang CHEN, Millburn, NJ (US); Manuel R. LOPEZ, Branchburg, NJ (US); Rakesh PATEL, East Windsor, NJ (US)

(73) Assignee: VERIZON PATENT AND LICENSING INC., Basking Ridge, NJ (US)

(21) Appl. No.: 18/978,077

(22) Filed: Dec. 12, 2024

(51) Int. Cl. H04W 8/20

(52) U.S. Cl. CPC H04W 8/20

(57) ABSTRACT

Disclosed are systems and methods that provide computerized eSIM SKU mapping framework. The disclosed eSIM SKU mapping framework operates an intelligent software solution that simplifies eSIM profile activation by scanning a QR code generated by a mobile device's LPA application. The framework extracts critical eUICC details, such as the 32-digit EID, SGP version, TCA version, and memory specifications to determine profile compatibility. By querying wireless operator backend systems and the Device Master Database, the framework can generate a list of compatible eSIM profiles and SKUs. Operations can then be performed for selection and activation of a preferred profile, streamlining the complex process of eSIM configuration across consumer and IoT devices.

### BACKGROUND INFORMATION

Embedded Subscriber Identity Module (eSIM) (or Embedded Universal Integrated Circuit Card (eUICC)) mobile devices are becoming more and more popular. eSIMs are SIM cards that are built into modern devices that allow users to activate a wireless plan without a physical SIM.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example network architecture according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates a non-limiting example embodiment of a network architecture according to some embodiments of the present disclosure; and

FIG. 5 is a block diagram illustrating a computing device showing an example of a client or server device used in various embodiments of the present disclosure.

### DETAILED DESCRIPTION OF EXAMPLE EMBODIMENTS

Currently, industry trends are for eSIM only devices, without the traditional physical SIM tray on such devices. This, among other technical issues, has resulted in an increased amount of processing for wireless network operators to create and map the eSIM device to a compatible eSIM SKU (stock keeping unit) for testing and commercial launch purposes.

Conventionally, the eSIM SKU mapping process is a complete manual process. For example, in the onboarding process, mobile device original equipment manufacturer (OEM) submit an eSIM compliance sheet, which includes the eUICC/eSIM card details, including industry standard specifications and versions that it complies to, such as, for example, Subscriber Group Preference/Profile (SGP) version, Telecommunications Cloud Authentication (TCA) version, Global System for Mobile Communications (GSMA) certification reference or declaration number, 5G support or not, volatile memory and/or non-volatile memory sizes, and the like. Based on such information, a marketing lead can manually pick and assign a compatible eSIM SKU to the device, and load the assigned eSIM SKU to a DMD (device management database) for the backend information technology (IT) system (e.g., eSIM SKU database) to provision live network service and activate the device when a customer places an order for the device and associated live network services.

Such manual eSIM SKU mapping process accounts for many technical shortcomings. For example, for a new/commercial device eSIM SKU mapping, mobile devices that use an eSIM that is not compatible to 5G eSIM profile (e.g., if a 5G eSIM profile is assigned mistakenly), the device will fail to activate its eSIM service due to the failure of profile installation onto the eSIM card. Therefore, it requires frequent communication to ensure the correct eSIM SKU is mapped, otherwise the above mistake may occur and cause big customer impact.

In another example of existing technical shortcomings of the manual mapping processes, for old/legacy test devices eSIM SKU change, over time the eSIM profiles will be updated for new features and bug fixes purpose, and new eSIM profiles and associated SKUs will become available. Testing eSIM SKU will always track and use the latest eSIM SKU. However, in the case that an old/legacy test device's eSIM card is not compatible with the latest eSIM profile, eSIM activation will fail for OEM or wireless operator internal testing, requiring resources in troubleshooting.

To that end, according to some embodiments, the disclosed systems and methods provide a n automated eSIM SKU mapping framework that operates as an intelligent software-based eSIM discovery tool that can automatically generate, assign and store, for use during device activation (and/or for an eSIM profile download), an updated and/or updateable eSIM SKU for a device. In some embodiments, as discussed herein, the disclosed eSIM discovery tool provides an advanced solution designed to streamline the process of identifying and activating compatible eSIM profiles across mobile and Internet of Things (IoT) devices. As discussed herein, in some embodiments, the disclosed framework can operate to leverage a sophisticated Quick Response (QR) code-based discovery mechanism that bridges mobile device hardware capabilities with wireless operator backend systems.

As discussed below in more detail, the intelligent discovery mechanisms provided herein can significantly improve the complex process of eSIM profile selection and activation by reducing manual intervention and minimizing potential configuration errors. By providing a standardized, technologically advanced approach to eSIM management, the disclosed systems and methods provide a critical innovation in telecommunications device provisioning.

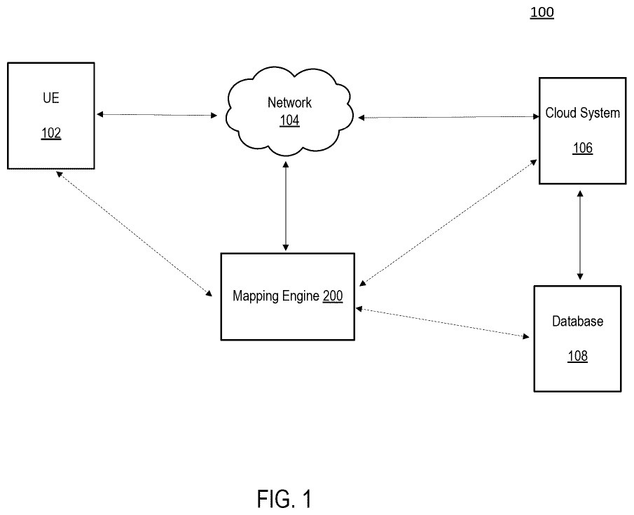

With reference to FIG. 1, system 100 is depicted which includes user equipment (UE) 102, network 104, cloud system 106, database 108, and mapping engine 200. It should be understood that while system 100 is depicted as including such components, it should not be construed as limiting, as varying numbers of UEs, engines, cloud systems, databases and networks can be utilized; however, for purposes of explanation, system 100 is discussed in relation to the example depiction in FIG. 1.

According to some embodiments, UE 102 can be any type of end-device operated in a mobile wireless network. For example, UE 102 can include, but not be limited to, a mobile phone, tablet, laptop, Internet of Things (IoT) device, wearable device, an autonomous guided vehicle (AGV), autonomous mobile robot (AMR), unmanned aerial vehicle (UAV), and/or any other type of device equipped with an eSIM.

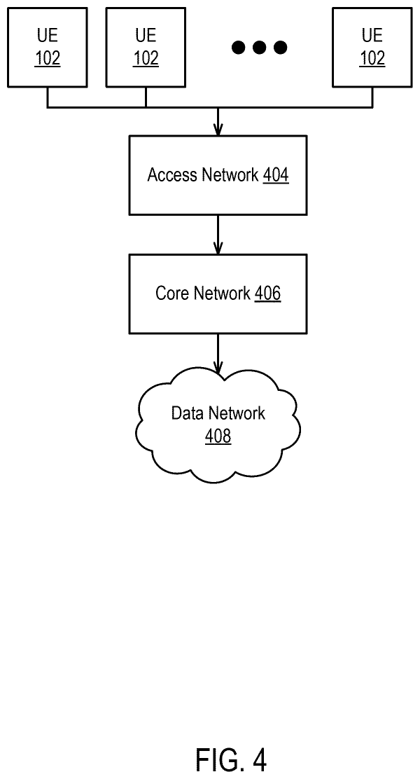

In some embodiments, network 104 can be any type of network or group of networks, and can facilitate connectivity of the components of system 100, as illustrated in FIG. 1. Further discussion of embodiments of network 104 are provided below with reference to FIG. 4.

According to some embodiments, cloud system 106 may be any type of cloud operating platform and/or network-based system upon which applications, operations, and/or other forms of network resources may be located. For example, cloud system 106 may be a service provider and/or network provider from where services and/or applications may be accessed, sourced or executed. For example, system 106 can represent the cloud-based infrastructure associated with a Mobile Network Operator (MNO) or the tenant of a dedicated network (e.g., network 104), and communicates with associated network resources hosted in a private or neutral host network (e.g., network 104).

In some embodiments, cloud system 106 may include a server(s) and/or a database of information. In some embodiments, a database 108 may store a set of data and/or metadata associated with network information related to the components, devices and/or the users (e.g., UEs 102) of system 100. In addition, database 108 may store eSIM SKUs and/or QR code information generated and/or used by a mapping engine 200.

In some embodiments, cloud system 106 can provide a private/proprietary management platform for network 104 and other devices/platforms operating thereon, and further host and/or communicate with mapping engine 200.

According to some embodiments, database 108 may correspond to a data storage for a platform (e.g., a network hosted platform, such as cloud system 106) or a plurality of platforms. Database 108 may receive storage instructions/requests from, for example, mapping engine 200 (and associated microservices), which may be in any type of known or to be known format, such as, for example, standard query language (SQL). Database 108 may correspond to any type of known or to be known storage, for example, a memory or memory stack of a device, a distributed ledger of a distributed network (e.g., blockchain, for example), a look-up table (LUT), and/or any other type of secure data repository.

Mapping engine 200, as discussed above and further below in more detail, can include components for the disclosed functionality. According to some embodiments, mapping engine 200 may be a special-purpose machine or processor or virtual machine within cloud system 106, or hosted by a device (or component) on network 104. In some embodiments, mapping engine 200 may be hosted by a server and/or set of servers associated with cloud system 106 or any other network.

According to some embodiments, mapping engine 200 may be configured to implement and/or control a plurality of services and/or microservices, where each of the plurality of services/microservices are configured to execute a plurality of workflows associated with performing the disclosed estimation of backhaul bandwidth and private core capacity. Non-limiting embodiments of such workflows are provided below.

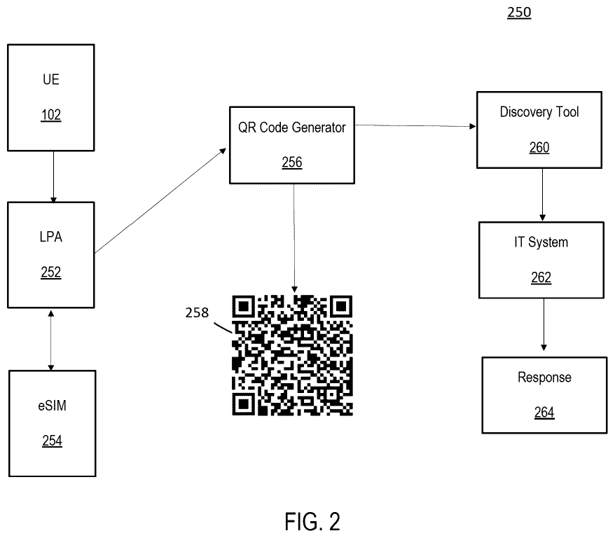

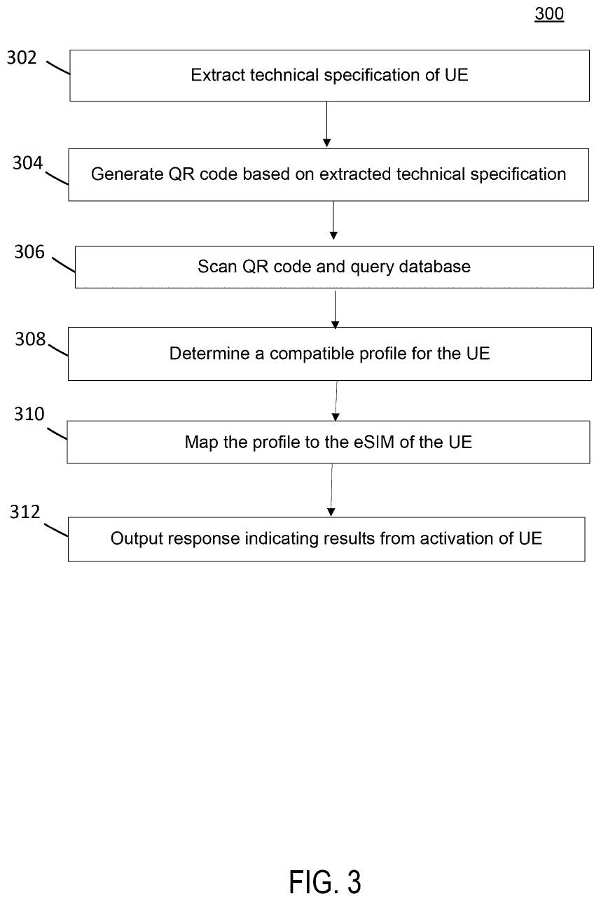

According to some embodiments, mapping engine 200 may function as an application provided by and/or hosted by cloud system 106. In some embodiments, mapping engine 200 can be embodied as an application executing on UE 102 (e.g., downloaded and/or web-based execution, for example). In some embodiments, mapping engine 200 may function as an application installed on a server(s), network location and/or other type of network resource associated with cloud system 106 and/or network 104. In some embodiments, mapping engine 200 may be configured and/or installed as an augmenting script, program or application (e.g., a plug-in or extension) to another application or program provided by cloud system 106 and/or network 104 that is executed over network 104 and/or on UE 102. In some embodiments, mapping engine 200's components can function on disparate locations on a network - for example, on a UE, on a device on the network, and/or on the cloud, as discussed below with reference to at least FIGS. 2 and 3.

FIG. 2 depicts a non-limiting example embodiment of the architecture 250 for which mapping engine 200 can operate. Architecture 250 in FIG. 2 may include UE 102, local profile assistant (LPA) 252 application, eSIM 254, QR code generator 256, QR code 258, discovery tool 260, IT system 262 and response 264. The operations and functionality of architecture 250 will be discussed in FIG. 3, with reference to the operational steps of engine 200.

According to some embodiments, Process 300 of FIG. 3 begins with Step 302 where the LPA 252 operates to extract technical specification information from the UE 102 (e.g., mobile device). The LPA 252 can extract critical technical specifications from the UE based on the LPA 252 having system-level privileges to communicate directly with the eUICC embedded in the UE—for example, the LPA 252 can directly query eSIM 254 on UE 102.

According to some embodiments, the extracted data can include, but is not limited to:
Device eUICC EID (Embedded Identity Document): A 32-digit identifier unique to each eUICC, ensuring precise identification of the hardware;
eUICC SGP Version: this version indicates compliance with specific eSIM standards: i) SGP.22 (user (e.g., consumer) eUICC specifications, mapping to user eSIM SKUs), and ii) SGP.31 (M2M/IoT eUICC specifications, mapping to M2M/IoT SKUs).
eUICC TCA Version: Managed by the Trusted Connectivity Alliance, this version dictates compatibility with 4G or 5G profiles: i) TCA 2.3.1 or newer (compatible with 5G profiles), and ii) older versions (limited to 4G profiles);
BER-TLV Support: indicates whether the eUICC supports secure Basic Encoding Rules-Tag Length Value (BER-TLV), necessary for 5G profile installation;
Memory capacities: i) Volatile Memory (VM): Determines how many operational eSIM profiles can be temporarily stored, and ii) Non-Volatile Memory (NVM): Dictates long-term storage capacity for eSIM profiles.

According to some embodiments, the extraction in Step 302 can be performed via the LPA 252 querying the eUICC in real time, eliminating potential human error and ensuring that critical specifications are always accurate. Live data extraction can be essential for precise profile determination, ensuring seamless eSIM activation without manual intervention, as discussed herein.

According to some embodiments, Step 302 can be triggered based on input for the UE 102 to be activated. In some embodiments, such input can correspond to, but not be limited to, turning on a device (e.g., for a first time after purchase or reset), a request, or other forms of input—for example, user interaction with displayed information (e.g., clicking (or “tapping” or ‘Long press’)), which can be, for example tapping the EID (unique identifier for the eSIM 254 and/or UE 102) or IMEI 1 or IMEI 2 or single IMEI at least a threshold number of times (e.g., 7 times for example).

In Step 304, a QR code 258 can be generated based on the extracted technical specifications obtained from Step 302. According to some embodiments, LPA 252 can communicate the technical specifications to the QR code generator 256, whereby the QR code 258 can be generated. The QR code 258 can include information such as, but not limited to, EID, SGP Version (determines whether the eSIM complies with consumer or M2M/IoT standards), TCA Version (ensures compatibility with 4G or 5G profiles), BER-TLV Support (indicates whether secure data transmission is supported), memory details (VM/NVM) (e.g., assesses profile storage capacity), and the like.

By way of a non-limiting example, according to some embodiments, QR code 258 can correspond to QR code string:
EID89049012345678901234567890123456; SGP.22v2.2.1; TCA2.3.1; BERTLV:Y; VM:600 KB; NVM:19 KB
Where:
SGP.22 indicates compliance with consumer eUICC standards;
TCA 2.3.1 and BER-TLV support confirm compatibility with both 4G and 5G profiles; and
Memory sizes guide profile storage capacity decisions.

Accordingly, the generated QR code 258 encapsulates all necessary data to proceed with backend system queries and profile determination, as per the subsequent steps of Process 300 (as performed by components 260-264 in FIG. 2, discussed infra).

In Step 306, a discovery tool, 260, can be used to scan the QR code 258, for which a database(s) query (or queries) can be performed. According to some embodiments, the QR code 258 can be scanned whereby backend IT system 262 (for example, eSIM SKU database and/or device management database (DMD) (e.g., database 108)) can be mined for compatible profiles of the eSIM 254 of UE 102. According to some embodiments, a DMD can be utilized to store product details and attributes, thereby ensuring accurate profile mapping based on device capabilities. In some embodiments, IT system 262 can integrate with a wireless operator's IT infrastructure to retrieve information about existing eSIM SKUs and operational profiles.

In some embodiments, the query process in Step 306 can involve performing a profile compatibility check (e.g., cross-referencing the eSIM specifications with stored eSIM SKUs to identify a list of compatible profiles), and then using the International Mobile Equipment Identity (IMEI) and EID of the UE to check if an existing SKU is already assigned, thereby preventing duplication or conflicts with activation. In some embodiments, the IMEI and EID can be included in the information extracted from the eSIM and included/represented in the QR code 258.

In Step 308, based on the extracted technical information and the queried database results, a list of compatible eSIM profiles can be determined. In some embodiments, such determination can be based on information related to, but not limited to, eSIM type (user or M2M/IoT based on SGP version), network support (e.g., 4G or 5G based on TCA version and BER-TLV support), memory constraints (e.g., ensuring the available memory can accommodate the selected profiles without exceeding capacity), and the like.

By way of non-limiting example, in some embodiments, if the eUICC is SGP.22 and TCA 2.3.1, engine 200 can list both 4G and 5G consumer profiles. In another non-limiting example, if BER-TLV is unsupported, only 4G profiles will be listed, regardless of TCA version.

In Step 310, once the compatible profile is determined, such profile can be mapped to the eSIM. Step 310 involves profile selection, whereby the selected compatible profile mapped to the eSIM for activation/assignment, downloaded to the UE from the wireless network operator's server, and securely installed onto the eUICC on the UE 102 (e.g., using BER-TLV for 5G profiles). In some embodiments, the installation of the profile can be verified by querying the eUICC for a newly installed profile.

In Step 312, after profile activation, a response to the input (from Step 302) can be generated and provided as an indication of the outcome of the eSIM mapping. The response 264 can provide information related to the eSIM SKU allocation to the selected profile. According to some embodiments, the response 264 can be a message or other type of indication that provides guidance on the activation status of the UE 102.

In some embodiments, the response 264 can provide an output scenario - for example: i) Success (Green OK Message): the eSIM profile is successfully installed, and the existing SKU matches a compatible profile, or ii) Error (Red Alert Message): the existing SKU does not match any compatible profiles, requiring a reassignment of a suitable SKU (or reperformance of Process 300).

In some embodiments, the response 264 can provide reporting of the activation processing of Process 300, which can include, but is not limited to, activation logs (e.g., detailed logs of the process, from QR code generation to profile mapping and activation), error resolution guidance (e.g., steps to resolve compatibility issues, ensuring smooth reactivation if needed), and the like.

Accordingly, the operations of the steps of Process 300 as performed by the components of FIG. 2, as detailed above, provide a transformative approach to mobile connectivity, leveraging automation and precision to eliminate errors and streamline the eSIM profile management process. Such operations ensure a seamless, accurate and efficient eSIM activation for both user (e.g., consumer) and M2M/IoT environments.

FIG. 4 is a block diagram of an example network architecture according to some embodiments of the present disclosure. In the illustrated embodiment, UE 102 accesses a data network 408 via an access network 404 and a core network 406.

In the illustrated embodiment, the access network 404 comprises a network allowing network communication with UE 102. In general, the access network 404 includes at least one base station that is communicatively coupled to the core network 406 and coupled to zero or more UE 102.

In some embodiments, the access network 404 comprises a cellular access network, for example, a 4G network. In an embodiment, the access network 404 can include a NextGen Radio Access Network (NG-RAN). In an embodiment, the access network 404 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 404 provides access to a core network 406 to UE 102. In the illustrated embodiment, the core network may be owned and/or operated by a mobile network operator (MNO) and provides wireless connectivity to UE 102. In the illustrated embodiment, this connectivity may comprise voice and data services.

At a high-level, the core network 406 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 406 and to external network-attached elements in a data network 408 such as the Internet.

In the illustrated embodiment, the access network 404 and the core network 406 are operated by an MNO. However, in some embodiments, the networks (404, 406) may be operated by a private entity and may be closed to public traffic. For example, the components of the network 406 may be provided as a single device, and the access network 404 may comprise a small form-factor base station. In these embodiments, the operator of the device can simulate a cellular network, and UE 102 can connect to this network similar to connecting to a national or regional network.

In some embodiments, the access network 404, core network 406 and data network 408 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

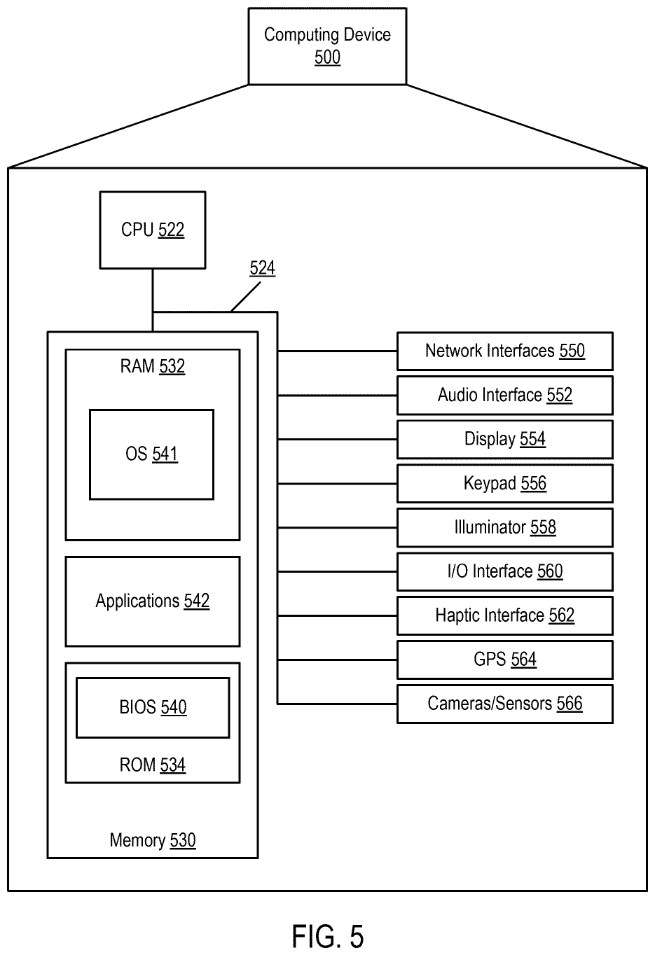

FIG. 5 is a block diagram illustrating a computing device showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, GPS receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a CPU 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple buses instead of a single bus.

Mass memory 530 illustrates another example of computer storage media for the storage of information such as computer-readable instructions, data structures, program modules, or other data. Mass memory 530 stores a basic input/output system (“BIOS”) 540 for controlling the low-level operation of the computing device 500. The mass memory also stores an operating system 541 for controlling the operation of the computing device 500.

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to ROM 534.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special-purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
extracting, by a Local Profile Assistant (LPA) application, information from an Embedded Subscriber Identity Module (eSIM) of a device;
generating, based on the extracted information, a code, the code being a representation of a code string that corresponds to the extracted information;
communicating, via the device, the generated code, wherein, the communicating causing compatibility operations of the eSIM to be mapped to a plurality of existing eSIM profiles;
receiving, in response to the communication, a compatible eSIM profile from the plurality of eSIM profiles, for the device; and
installing, by the device, the compatible eSIM profile.

2. The method of claim 1, wherein the installation comprises:
activating the device, via the eSIM profile, with a wireless network operator, the activation enabling wireless functionality for the device.

3. The method of claim 1, further comprising performing a verification of the installed eSIM profile by querying an Embedded Universal Integrated Circuit Card (eUICC) of the device.

4. The method of claim 1, wherein the compatibility operations perform a database search of at least one of an eSIM SKU database and device management database (DMD).

5. The method of claim 1, further comprising the LPA application querying the eSIM, such that the extraction is based on the query.

6. The method of claim 1, wherein the extracted information comprises information selected from a group consisting of: Embedded Identity Document (EID), Subscriber Group Preference/Profile (SGP) Version, Telecommunications Cloud Authentication (TCA) Version, Basic Encoding Rules - Tag Length Value (BER-TLV) Support, memory capacities, and International Mobile Equipment Identity (IMEI).

7. The method of claim 1, further comprising outputting by the device, a response indicating a status of the installation of the eSIM profile.

8. The method of claim 1, further comprising receiving input at the device, at least a threshold number of times, the input causing the extraction of the eSIM information.

9. A device comprising:
a processor configured to:
extract, by a Local Profile Assistant (LPA) application, information from an Embedded Subscriber Identity Module (eSIM) of the device;
generate, based on the extracted information, a code, the code being a representation of a code string that corresponds to the extracted information;
communicate the generated code, wherein, the communicating causing compatibility operations of the eSIM to be mapped to a plurality of existing eSIM profiles;
receive, in response to the communication, a compatible eSIM profile from the plurality of eSIM profiles, for the device; and
install the compatible eSIM profile.

10. The device of claim 9, wherein the processor is further configured to activate the device, via the eSIM profile with a wireless network operator, the activation enabling wireless functionality for the device.

11. The device of claim 9, wherein the processor is further configured to perform a verification of the installed eSIM profile by querying an Embedded Universal Integrated Circuit Card (eUICC) of the device.

12. The device of claim 9, wherein the processor is further configured such that the compatibility operations comprise a database search of at least one of an eSIM SKU database and device management database (DMD).

13. The device of claim 9, wherein the processor is further configured such that the LPA application queries the eSIM, such that the extraction is based on the query.

14. The device of claim 9, wherein the processor is further configured such that the extracted information comprises information selected from a group consisting of: Embedded Identity Document (EID), Subscriber Group Preference/Profile (SGP) Version, Telecommunications Cloud Authentication (TCA) Version, Basic Encoding Rules-Tag Length Value (BER-TLV) Support, memory capacities, and International Mobile Equipment Identity (IMEI).

15. The device of claim 9, wherein the processor is further configured to output a response indicating a status of the installation of the eSIM profile.

16. The device of claim 9, wherein the processor is further configured to receive input at least a threshold number of times, the input causing the extraction of the eSIM information.

17. A non-transitory computer-readable storage medium tangible encoded with computer-executable instructions, that when executed by a device, perform a method comprising:
extracting, by a Local Profile Assistant (LPA) application, information from an Embedded Subscriber Identity Module (eSIM) of the device;
generating, based on the extracted information, a code, the code being a representation of a code string that corresponds to the extracted information;
communicating, by the device, the generated code, wherein the communicating causing compatibility operations of the eSIM to be mapped to a plurality of existing eSIM profiles;
receiving, in response to the communication, a compatible eSIM profile from the plurality of eSIM profiles, for the device; and
installing, by the device, the compatible eSIM profile.

18. The non-transitory computer-readable storage medium of claim 17, wherein the installing comprises activating the device via the eSIM profile with a wireless network operator, the activation enabling wireless functionality for the device.

19. The non-transitory computer-readable storage medium of claim 17, further comprising performing a verification of the installed eSIM profile by querying an Embedded Universal Integrated Circuit Card (eUICC) of the device.

20. The non-transitory computer-readable storage medium of claim 17, wherein the compatibility operations comprise a database search of at least one of an eSIM SKU database and device management database (DMD).
